(19) United States
(12) Patent Application Publication
(10) Pub. No.: US 2014/0351075 A1
(43) Pub. Date: Nov. 27, 2014

(54) KIOSK FOR DISPENSING AND ACTIVATING USER DEVICES

(71) Applicant: Cellco Partnership d/b/a Verizon Wireless, Basking Ridge, NJ (US)

(72) Inventors: Michael J. D'ARGENIO, Green Brook, NJ (US); Kristopher T. Frazier, McKinney, TX (US); Lonnie Katai, Murphy, TX (US)

(73) Assignee: Cellco Partnership d/b/a Verizon Wireless, Basking Ridge, NJ (US)

(21) Appl. No.: 13/901,206

(22) Filed: May 23, 2013

(51) Int. Cl. G06Q 20/18; H04M 15/00; G06Q 30/06; H04W 4/00

(52) U.S. Cl. CPC G06Q 20/18; H04W 4/001; H04M 15/72; G06Q 30/0621
USPC 705/26.5

(57) ABSTRACT

A device may determine device information associated with a user device housed within a kiosk. The device information may identify the user device. The device may dispense the user device based on the device information. The device may receive an indication that the user device is to be purchased. The device may receive subscription information associated with the purchaser of the user device, based on receiving the indication. The device may provide activation information that permits the user device to be activated on a network. The activation information may be based on the subscription information.

### BACKGROUND

A purchaser may purchase a device (e.g., a cell phone) at a store associated with a service provider network. The purchaser may also provide subscription information associated with the device (e.g., a subscriber name, a subscriber account number, a contract term, a data plan, a quantity of monthly minutes, etc.) and may activate the device at the time of purchase. A device that has been activated may use services provided by the service provider network.

### BRIEF DESCRIPTION OF THE DRAWINGS

FIGS. 1A and 1B are diagrams of an overview of an example implementation described herein;

FIG. 2 is a diagram of an example environment in which systems and/or methods described herein may be implemented;

FIG. 3 is a diagram of example components of one or more devices of FIG. 2;

FIG. 4 is a flow chart of an example process for receiving subscription information and providing activation information associated with a purchase of a device at a kiosk; and

FIGS. 5A-5G are diagrams of an example implementation relating to the example process shown in FIG. 4.

### DETAILED DESCRIPTION

The following detailed description of example implementations refers to the accompanying drawings. The same reference numbers in different drawings may identify the same or similar elements.

A purchaser of a device (e.g., a cell phone) may wish to begin the purchase of the device using a website associated with a service provider network. The purchaser may provide subscription information (e.g., a subscriber name, a subscriber account number, a contract term, a data plan, a quantity of monthly minutes, etc.) via the service provider network website. However, the purchaser may wish to physically examine the device before completing the purchase. The purchaser may also want to examine the device, complete the purchase of the device, provide subscription information associated with the device, and activate the device without having to visit a store associated with the service provider network. Implementations described herein may allow a purchaser to complete the purchase, setup, and activation of a device at a kiosk without having to visit a store associated with a service provider network.

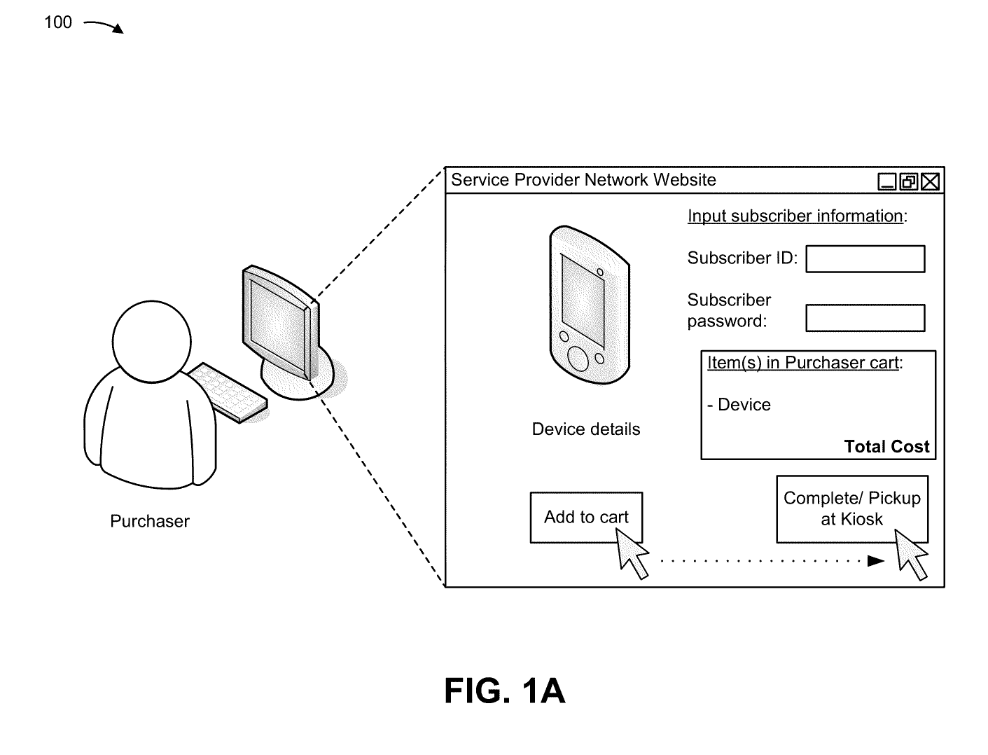

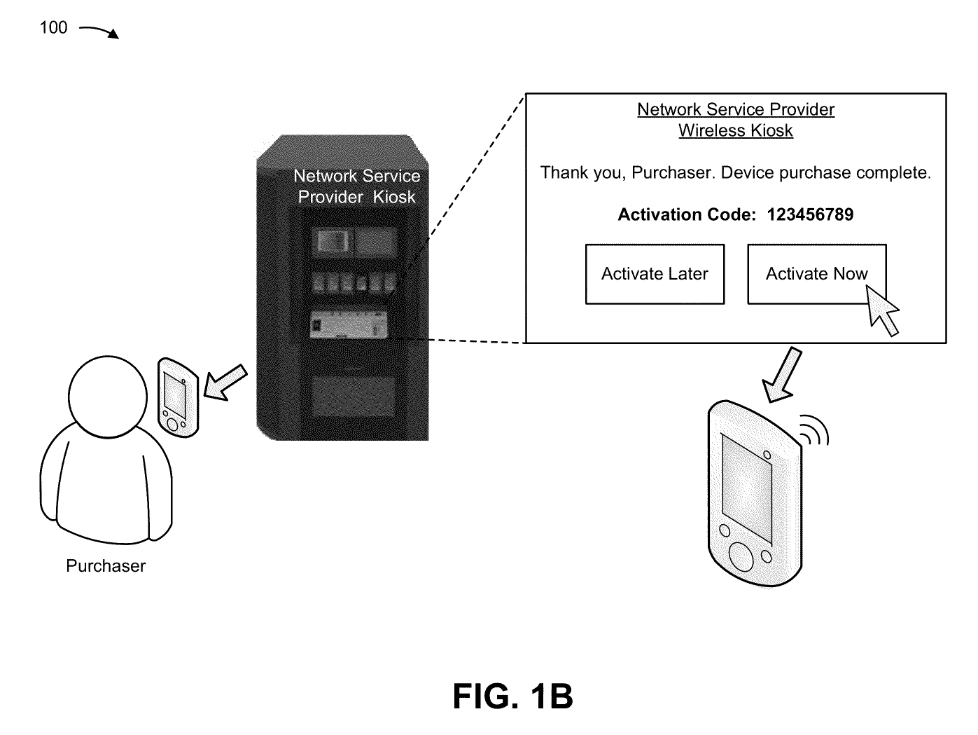

FIGS. 1A and 1B are diagrams of an overview of an example implementation 100 described herein. As shown in FIG. 1A, assume that a purchaser of a device accesses a website associated with a service provider network to begin a purchase of the device. Further, assume that the purchaser has an account associated with the service provider network website that may store an association between the account and information associated with the purchase of the device. Finally, assume that the purchaser wishes to examine the device, complete the purchase of the device, provide subscription information associated with the device, and activate the device at a kiosk (e.g., without having to visit a store associated with the service provider network).

As shown in FIG. 1A, the purchaser may select a device to purchase using a website associated with a service provider network. The purchaser may input subscription information (e.g., a subscriber account number, a subscriber name, a contract term, a data plan, a quantity of monthly minutes, etc.) associated with the services to be provided to the device by the service provider network. As shown, the purchaser may choose to complete the purchase of the device at a kiosk associated with the service provider network.

As shown in FIG. 1B, the purchaser may travel to a kiosk (e.g., a wireless kiosk) associated with the service provider network. The purchaser may access the account at the kiosk to retrieve information associated with the purchase that began using the service provider network website. As further shown in FIG. 1B, the kiosk may dispense the device to the purchaser. The kiosk may allow the purchaser to examine the device before completing the purchase. The kiosk may also allow the purchaser to activate the purchased device, based on the provided subscription information, as shown. In this way, a purchaser may purchase a device, provide subscription information associated with the device, and activate the device at a kiosk associated with a service provider network (e.g., without requiring the purchaser to visit a store associated with the service provider network).

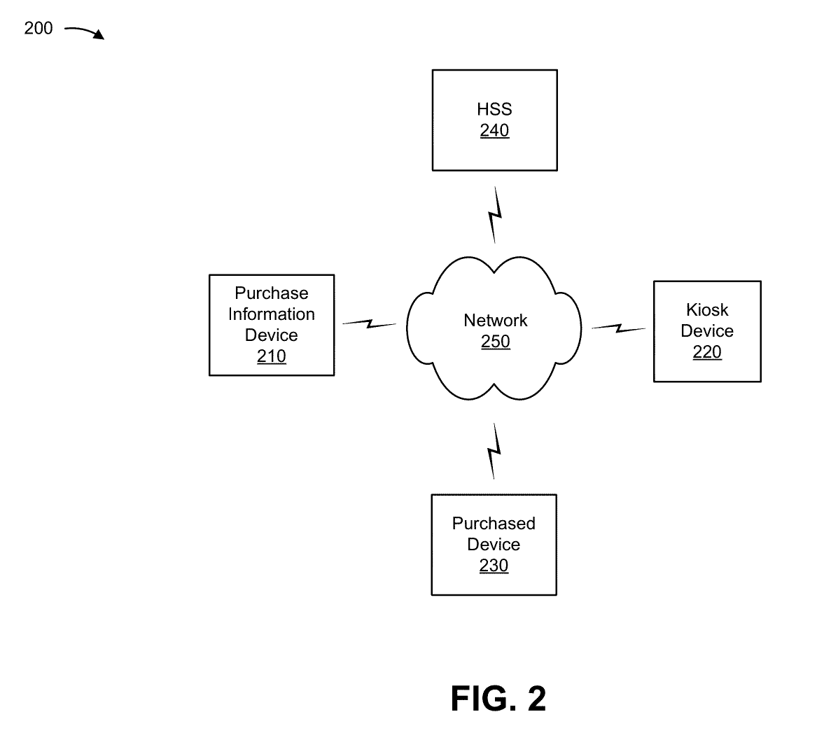

FIG. 2 is a diagram of an example environment 200 in which systems and/or methods described herein may be implemented. As shown in FIG. 2, environment 200 may include a purchase information device 210, a kiosk device 220, a purchased device 230, a home subscriber server (“HSS”) 240, and a network 250.

Purchase information device 210 may include a device capable of receiving, generating, processing, storing, and/or providing information associated with a purchase of a device (e.g., purchased device 230). For example, purchase information device 210 may include a computing device (e.g., a laptop computer, a desktop computer, a tablet computer, a server computer, etc.), a wireless communication device, a radiotelephone, a personal communications system (“PCS”) terminal (e.g., that may combine a cellular radiotelephone with data processing and data communications capabilities), a personal digital assistant (“PDA”) (e.g., that can include a radiotelephone, a pager, Internet/intranet access, etc.), a smart phone, and/or a similar device. Purchase information device 210 may send information associated with the purchase of the device to one or more other devices (e.g., kiosk device 220, HSS 240, etc.).

Kiosk device 220 may include a device capable of receiving, generating, processing, and/or providing information associated with the purchase of a device (e.g., purchased device 230), subscription information associated with the device, and/or activation information associated with the device. Additionally, or alternatively, kiosk device 220 may include a device capable of dispensing another device to a purchaser. In some implementations, kiosk device 220 may include an apparatus that may house one or more devices that are available for purchase by a purchaser. For example, the kiosk may house a device (e.g., purchased device 230) and may dispense the device to the purchaser based on purchaser input. Kiosk device 220 may receive and/or send information associated with the purchase of the device from and/or to another device (e.g., purchase information device 210, HSS 240, etc.). In some implementations, kiosk device 220 may include a mechanism (e.g., a camera, a display screen, a telephone, etc.) that may allow the purchaser to provide input and/or to communicate with a representative of the service provider network (e.g., a customer service representative). In some implementations, kiosk device 220 may be capable of wireless communication with another device (e.g., HSS 240) via a service provider network, allowing kiosk device 220 to be placed in a variety of locations.

Purchased device 230 may include a device housed in a kiosk (e.g., kiosk device 220). Additionally, or alternatively, purchased device 230 may include a device capable of communicating with a service provider network (e.g., after being activated). For example, purchased device 230 may include a wireless communication device, a radiotelephone, a personal communications system (“PCS”) terminal (e.g., that may combine a cellular radiotelephone with data processing and data communications capabilities), a personal digital assistant (“PDA”) (e.g., that can include a radiotelephone, a pager, Internet/intranet access, etc.), a smart phone, a laptop computer, a tablet computer, a personal gaming system, and/or a similar device. Purchased device 230 may be activated for use on the service provider network based on information provided by another device (e.g., purchase information device 210, kiosk device 220, HSS 240, etc.).

HSS 240 may include one or more devices, such as one or more server devices, capable of managing subscription and/or other information associated with purchased device 230. For example, HSS 240 may receive, store and/or provide profile information associated with purchased device 230 that identifies applications and/or services that are permitted for use by and/or accessible by purchased device 230, information associated with a purchaser of purchased device 230 (e.g., a username, a password, a personal identification number (“PIN”), etc.), activation information, subscription information, rate information, minutes allowed, bandwidth allocation policy information, and/or other information.

Network 250 may include one or more wired and/or wireless networks. For example, network 250 may include a cellular network, a public land mobile network (“PLMN”), a local area network (“LAN”), a wide area network (“WAN”), a metropolitan area network (“MAN”), a telephone network (e.g., the Public Switched Telephone Network (“PSTN”)), an ad hoc network, an intranet, the Internet, a fiber optic-based network, and/or a combination of these or other types of networks.

The number of devices and/or networks illustrated in FIG. 2 is provided for explanatory purposes. In practice, there may be additional devices and/or networks, fewer devices and/or networks, different devices and/or networks, or differently arranged devices and/or networks than those illustrated in FIG. 2. Furthermore, two or more of the devices illustrated in FIG. 2 may be implemented within a single device, or a single device illustrated in FIG. 2 may be implemented as multiple, distributed devices. Additionally, one or more of the devices of environment 200 may perform one or more functions described as being performed by another one or more of the devices of environment 200. Devices of environment 200 may interconnect via wired connections, wireless connections, or a combination of wired and wireless connections.

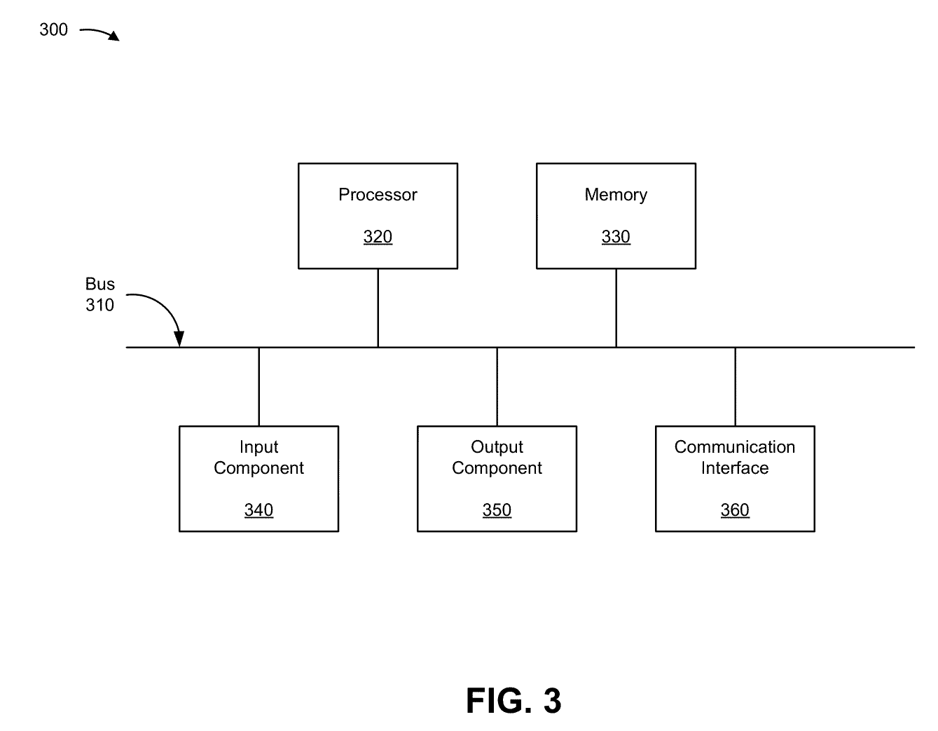

FIG. 3 is a diagram of example components of a device 300. Device 300 may correspond to purchase information device 210, kiosk device 220, purchased device 230, and/or HSS 240. Additionally, or alternatively, each of purchase information device 210, kiosk device 220, purchased device 230, and/or HSS 240 may include one or more devices 300 and/or one or more components of device 300. As illustrated in FIG. 3, device 300 may include a bus 310, a processor 320, a memory 330, an input component 340, an output component 350, and a communication interface 360.

Bus 310 may include a path that permits communication among the components of device 300. Processor 320 may include a processor, a microprocessor, and/or any processing component (e.g., a field-programmable gate array (“FPGA”), an application-specific integrated circuit (“ASIC”), etc.) that interprets and/or executes instructions. In some implementations, processor 320 may include one or more processor cores. Memory 330 may include a random access memory (“RAM”), a read only memory (“ROM”), and/or any type of dynamic or static storage device (e.g., a flash memory, a magnetic memory, an optical memory, etc.) that stores information and/or instructions for use by processor 320.

Input component 340 may include any component that permits a user to input information to device 300 (e.g., a keyboard, a keypad, a mouse, a button, a switch, etc.). Output component 350 may include any component that outputs information from device 300 (e.g., a display, a speaker, one or more light-emitting diodes (“LEDs”), etc.).

Communication interface 360 may include any transceiver-like component, such as a transceiver and/or a separate receiver and transmitter, that enables device 300 to communicate with other devices and/or systems, such as via a wired connection, a wireless connection, or a combination of wired and wireless connections. For example, communication interface 360 may include a component for communicating with another device and/or system via a network. Additionally, or alternatively, communication interface 360 may include a logical component with input and output ports, input and output systems, and/or other input and output components that facilitate the transmission of data to and/or from another device, such as an Ethernet interface, an optical interface, a coaxial interface, an infrared interface, a radio frequency (“RF”) interface, a universal serial bus (“USB”) interface, or the like.

Device 300 may perform various operations described herein. Device 300 may perform these operations in response to processor 320 executing software instructions included in a computer-readable medium, such as memory 330. A computer-readable medium may be defined as a non-transitory memory device. A memory device may include memory space within a single physical storage device or memory space spread across multiple physical storage devices.

Software instructions may be read into memory 330 from another computer-readable medium or from another device via communication interface 360. When executed, software instructions stored in memory 330 may cause processor 320 to perform one or more processes that are described herein. Additionally, or alternatively, hardwired circuitry may be used in place of or in combination with software instructions to perform one or more processes described herein. Thus, implementations described herein are not limited to any specific combination of hardware circuitry and software.

The number of components illustrated in FIG. 3 is provided for explanatory purposes. In practice, device 300 may include additional components, fewer components, different components, or differently arranged components than those illustrated in FIG. 3.

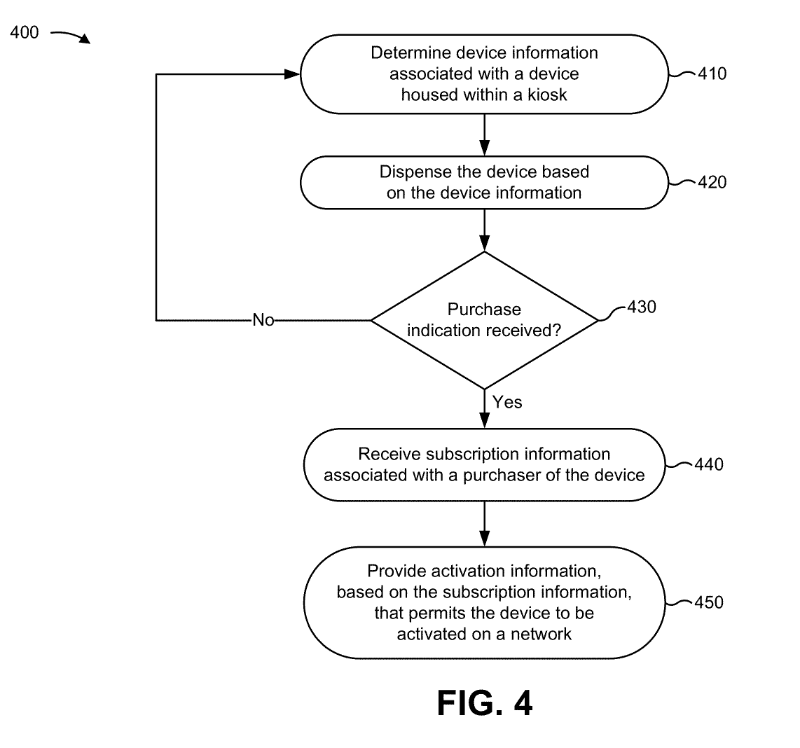

FIG. 4 is a flow chart of an example process 400 for receiving subscription information and providing activation information associated with a purchase of a device at a kiosk. In some implementations, one or more process blocks of FIG. 4 may be performed by kiosk device 220. In some implementations, one or more process blocks of FIG. 4 may be performed by another device or a group of devices separate from or including kiosk device 220, such as purchase information device 210, purchased device 230, and/or HSS 240.

As shown in FIG. 4, process 400 may include determining device information associated with a device housed within a kiosk (block 410). For example, kiosk device 220 may determine the device information. In some implementations, kiosk device 220 may determine the device information based on information received from another device (e.g., purchase information device 210). Additionally, or alternatively, kiosk device 220 may determine the device information based on input, from a purchaser, provided via a user interface displayed on kiosk device 220.

Device information, as used herein, may refer to information associated with a purchase of a device (e.g., purchased device 230). For example, device information may include information identifying a purchaser of the device (e.g., a name, an address, an email address, a username associated with the service provider network website, etc.), information identifying a service provider network subscriber (e.g., a subscriber account name, a subscriber account number, etc.), information that identifies the device (e.g., a make of the device, a model of the device, a device identifier, such as an international mobile subscriber identity (“IMSI”), a mobile subscriber integrated services digital network-number (“MSISDN”), a mobile directory number (“MDN”), etc.), information associated with subscription services to be provided to the device (e.g., a contract length, a contract type, a data plan, a quantity of monthly minutes, etc.), or the like.

In some implementations, kiosk device 220 may determine the device information based on input, from the purchaser, provided using kiosk device 220. For example, the purchaser may navigate a list of devices displayed on a display screen of kiosk device 220. Kiosk device 220 may display the list of devices based on devices housed within kiosk device 220. Additionally, or alternatively, the purchaser may provide a username and a password associated with the service provider network website, and kiosk device 220 may determine the device information based on input previously provided by the purchaser, via purchase information device 210, using the service provider network website.

In some implementations, the purchaser may request assistance (e.g., via a user interface of kiosk device 220), and may be connected to a customer service representative (e.g., on a video call via kiosk device 220, etc.). The customer service representative may input the device information. Additionally, or alternatively, the customer service representative may provide guidance to the purchaser (e.g., information regarding devices available for purchase, information regarding the operation of kiosk device 220, information regarding the purchase and activation process in general, etc.).

As further shown in FIG. 4, process 400 may include dispensing the device based on the device information (block 420). For example, kiosk device 220 may dispense the device (e.g., purchased device 230), housed within kiosk device 220, based on the device information. In some implementations, kiosk device 220 may dispense the device after receiving payment and/or identity information associated with the purchaser (e.g., credit card information, a driver's license number, etc.), provided via a user interface of kiosk device 220.

In some implementations, kiosk device 220 may collect the device from the purchaser after kiosk device 220 has dispensed the device (e.g., the purchaser has examined the device and decided not to purchase the device). For example, the purchaser may indicate (by clicking a “Return Device” button on a user interface of kiosk device 220) that the purchaser has decided to return the device to kiosk device 220 (e.g., the purchaser does not want to purchase the device). In some implementations, kiosk device 220 may include a mechanism to collect the device from the purchaser (e.g., a doorway, a receiving slot, an opening, etc.). Additionally, or alternatively, kiosk device 220 may include a mechanism to return the collected device to a particular location within the housing of kiosk device 220 (e.g., a location where the device was dispensed from, etc.) so the device may be dispensed for a future purchase.

In some implementations, kiosk device 220 may dispense a demonstration (“demo”) device (e.g., another device that may be the identical make and model of the device) to the purchaser. In some implementations, the demo device may have limited functionality activated to permit the purchaser to interact with the demo device.

In some implementations, the demo device may be programmed with information associated with purchaser (e.g., information associated with a contact of the purchaser, an application installed on another device associated with the purchaser, etc.) before being dispensed. The information associated with the purchaser may be determined based on information stored by another network device associated with the service provider network (e.g., an application server, etc.).

In some implementations, the demo device may be reprogrammed to include information associated with the current purchaser each time the demo device is dispensed. Additionally, or alternatively, information associated with the purchaser that is programmed onto the demo device may be deleted when the demo device is collected by the kiosk.

In some implementations, a device identifier of the demo device may be stored by a device in the service provider network (e.g., HSS 240) to prevent the demo device from being activated (e.g., if the purchaser does not return the demo device). In some implementations, the purchaser may be charged for a loss of, or damage to, the demo device. Kiosk device 220 may collect the demo device from the purchaser, prior to dispensing the device (e.g., purchased device 230). For example, kiosk device 220 may determine, based on user input provided via a user interface of kiosk device 220, that the purchaser is permitted (e.g., by providing credit card information, by providing a driver's license number, etc.) to examine the demo device prior to completing the purchase of purchased device 230. Kiosk device 220 may dispense the demo device, and may subsequently collect the demo device (e.g., using a doorway, using a receiving slot, etc.) when the purchaser completes the examination. In some implementations, kiosk device 220 may dispense the device (e.g., purchased device 230) to the purchaser after the demo device is collected from the purchaser.

In some implementations, kiosk device 220 may dispense multiple devices to allow the purchaser to compare the multiple devices. In some implementations, kiosk device 220 may limit the quantity of devices that may be dispensed and/or may not allow activation of any dispensed device until all but one of the multiple devices has been collected by kiosk device 220.

As further shown in FIG. 4, process 400 may include determining whether a purchase indication has been received (block 430). For example, kiosk device 220 may determine whether a purchase indication associated with the device (e.g., purchased device 230) has been received. In some implementations, the purchase indication may indicate that the purchaser has (or has not) completed the purchase of the device.

In some implementations, the purchase indication may be based on payment information (e.g., credit card information, etc.) provided by the purchaser to complete the purchase of the device. Additionally, or alternatively, the purchase indication may be based on an indication that the device has been dispensed to the purchaser by kiosk device 220. Additionally, or alternatively, the purchase indication may be based on input, from the purchaser (e.g., by clicking on a “Purchase” button, by clicking a “Do Not Purchase” button, etc.), provided via a user interface of kiosk device 220.

As further shown in FIG. 4, if the purchase indication has not been received (block 430—NO), then process 400 may include returning to block 410. For example, kiosk device 220 may determine that a purchase indication has not been received, based on input provided by the purchaser via a user interface displayed on kiosk device 220. Additionally, or alternatively, kiosk device 220 may determine that the purchase indication has not been received based on collecting the device from the purchaser (e.g., the purchaser may return the device to the kiosk after the device is dispensed). Based on the determination, kiosk device 220 may determine device information associated with another device in kiosk device 220 (e.g., the purchaser may select a different device to purchase) and may proceed as discussed above. Alternatively, the purchaser may not specify another device, and kiosk device 220 may return the dispensed device to the proper location within the housing of kiosk device 220.

As further shown in FIG. 4, if the purchase indication has been received (block 430—YES), then process 400 may include receiving subscription information associated with the purchaser of the device (block 440). For example, kiosk device 220 may determine that a purchase indication has been received, based on input provided by the purchaser via a user interface displayed on kiosk device 220. Based on the determination, kiosk device 220 may receive subscription information associated with the purchaser of the device.

In some implementations, the subscription information may be based on the device information and/or based on information received from another device (e.g., purchase information device 210, purchased device 230, HSS 240, etc.). Additionally, or alternatively, the subscription information may be based on input, from the purchaser, provided via a user interface displayed on kiosk device 220. In some implementations, the purchaser of the device may be a user of the device.

Subscription information may include information associated with the purchaser and/or information associated with services to be provided to the device by the service provider network. For example, subscription information may include information identifying the purchaser (e.g., a name, an address, an email address, a telephone number, a subscriber identifier associated with the purchaser, a subscriber account number associated with the purchaser, etc.), information identifying the device (e.g., a make of the device, a model of the device, an IMSI, an MSISDN, an MDN, etc.), information associated with services provided to the device via the service provider network (e.g., a quantity of monthly data, a quantity of monthly minutes, a quantity of monthly text messages, etc.), information associated with the type and/or duration of the subscription (e.g., a contract term, a monthly plan, a prepaid plan, a pay-as-you-go plan, etc.), payment information associated with the purchaser (e.g., a billing address, a checking account number, a credit card number, etc.), or the like.

As further shown in FIG. 4, process 400 may include providing activation information, based on the subscription information, that permits the device to be activated on a network (block 450). For example, kiosk device 220 may provide activation information, based on the subscription information, to HSS 240. In some implementations, kiosk device 220 may provide the activation information to HSS 240 when the kiosk device 220 has received the subscription information. Additionally, or alternatively, kiosk device 220 may provide the activation information when the purchase of the device is complete (e.g., the purchase of the device using a credit card has been approved). Additionally, or alternatively, kiosk device 220 may provide the activation information based on input provided by the purchaser, via a user interface displayed on kiosk device 220 (e.g., the purchaser has clicked an “Activate Now” button, the purchaser has clicked an “Activate Later” button, etc.). In some implementations, kiosk device 220 may program a removable component of the device (e.g., a universal integrated circuit card (“UICC”), a subscriber identity module (“SIM”) card, etc.) with activation information. Kiosk device 220 may dispense the removable component to the purchaser and the purchaser may insert the removable component into the device (e.g., purchased device 230).

Activation information, as used herein, may refer to information associated with making a device operable on a service provider network. In some implementations, the activation information may be based on the subscription information received by kiosk device 220. Additionally, or alternatively, the activation information may be based on information received from another device (e.g., purchase information device 210, purchased device 230, etc.). The activation information may be based on the subscription information associated with the device (e.g., purchased device 230).

In some implementations, the device (e.g., purchased device 230) may be activated on a service provider network based on activation information being provided to another device associated with the service provider network. For example, the activation information may be provided to HSS 240, which may store the activation information, perform authentication of the device, and/or perform authorization of the device. Activation of the device may take place when an activation request is received (e.g., from kiosk device 220, purchased device 230, etc.). Upon receiving an activation request, a network device associated with activation (e.g., HSS 240) may authenticate the device, based on the activation information, and may activate the device for use on the service provider network (e.g., may permit the device to access the service provider network).

In some implementations, HSS 240 may activate purchased device 230 (e.g., permit purchased device 230 to access the service provider network) based on storing the activation information. Alternatively, HSS 240 may store the activation information and may not activate purchased device 230 (e.g., based on an indication that purchased device 230 is to be activated in the future).

In some implementations, HSS 240 may activate purchased device 230 based on an indication (e.g., input provided via a user interface of kiosk device 220) received from kiosk device 220 indicating that purchased device 230 is to be activated. Additionally, or alternatively, HSS 240 may activate purchased device 230 based on an indication received from purchased device 230 (e.g., the purchaser wishes to activate purchased device 230 using purchased device 230 itself).

While a series of blocks has been described with regard to FIG. 4, the blocks and/or the order of the blocks may be modified in some implementations. Additionally, or alternatively, non-dependent blocks may be performed in parallel. Further, one or more blocks may be omitted.

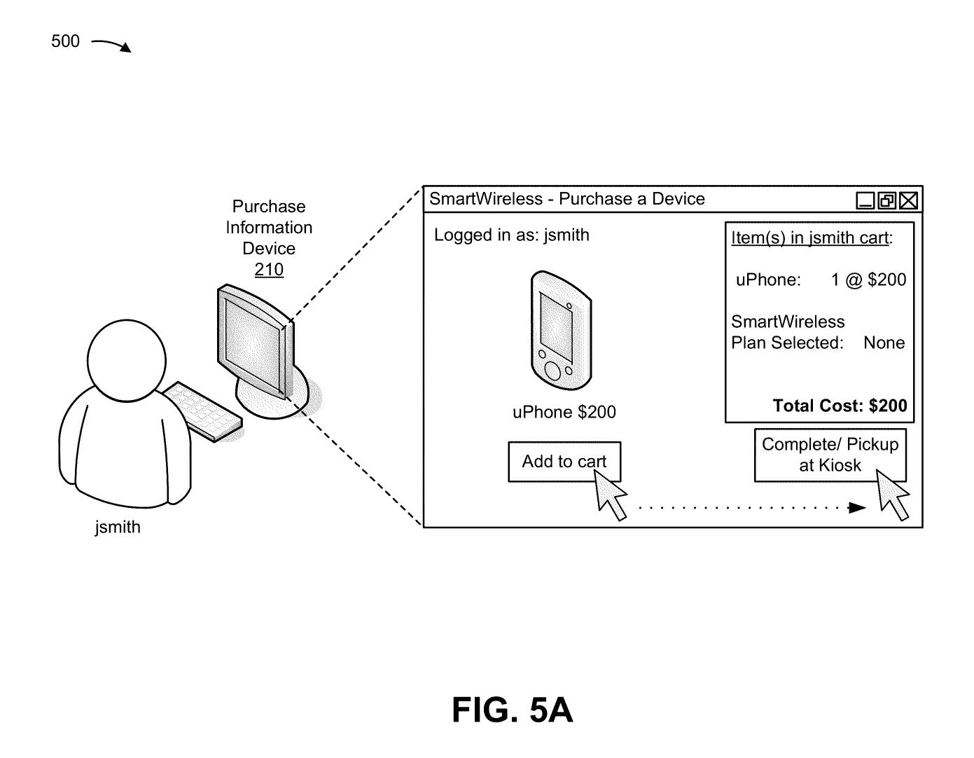

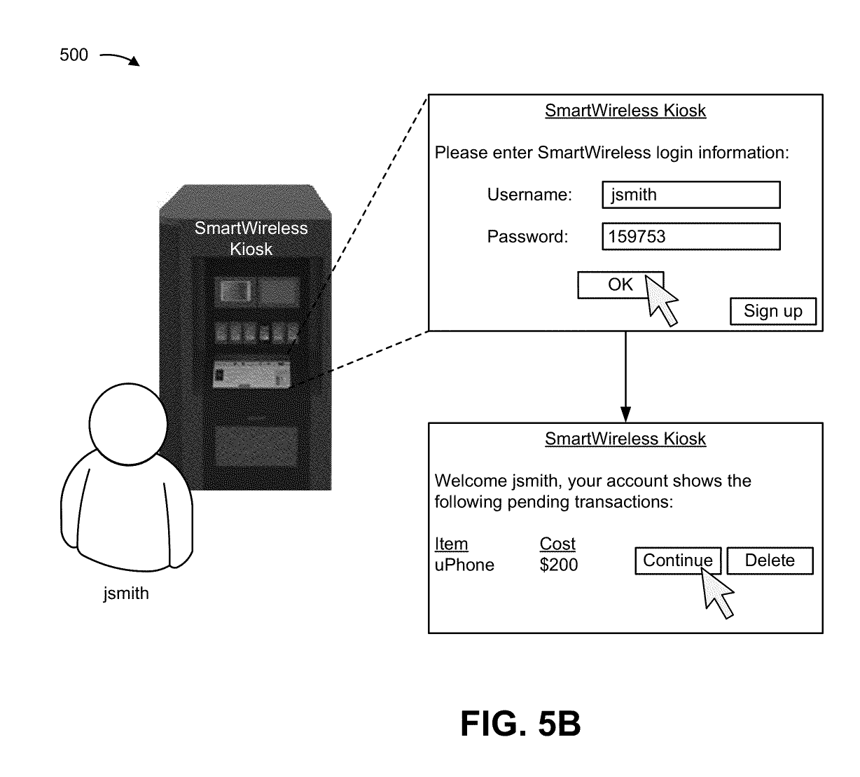

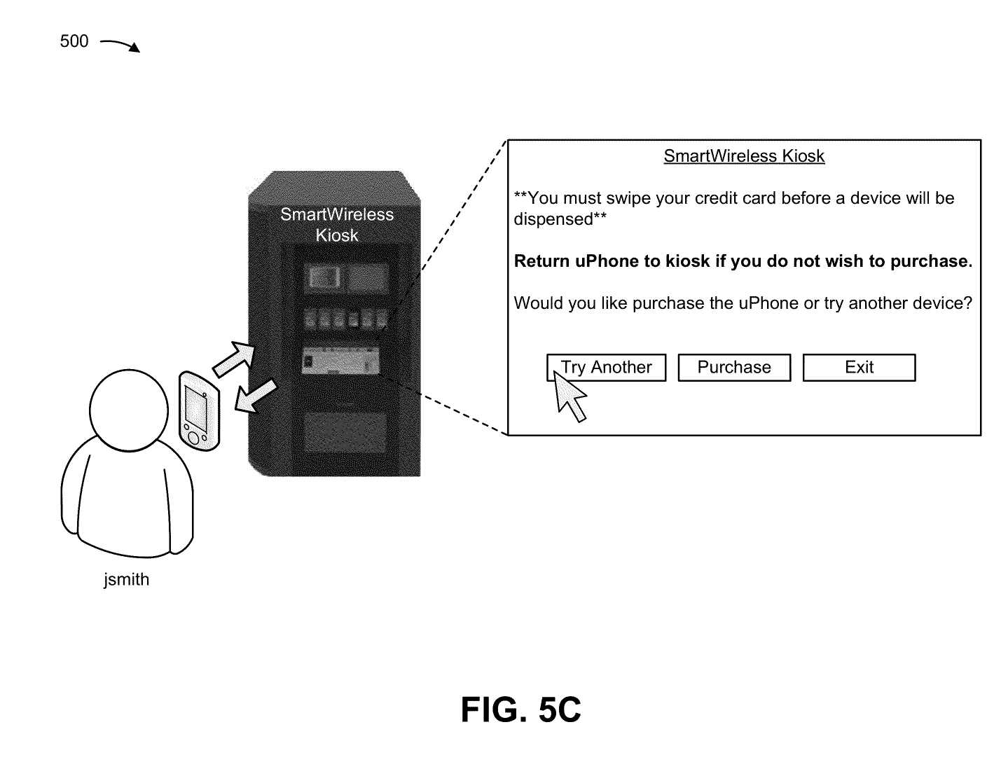

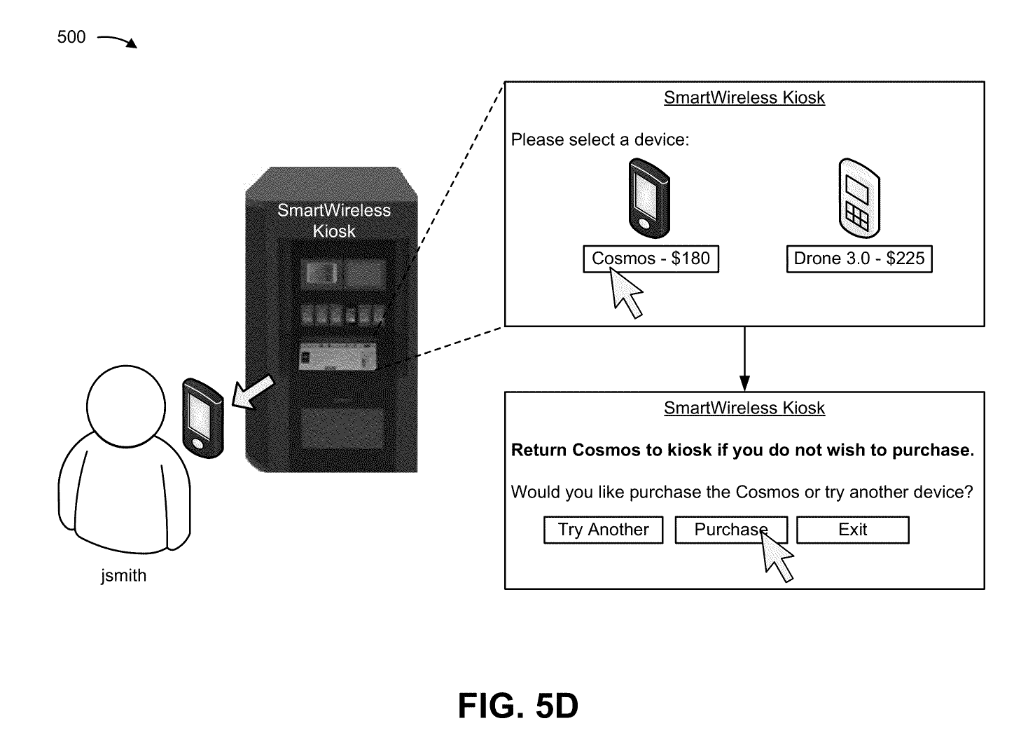

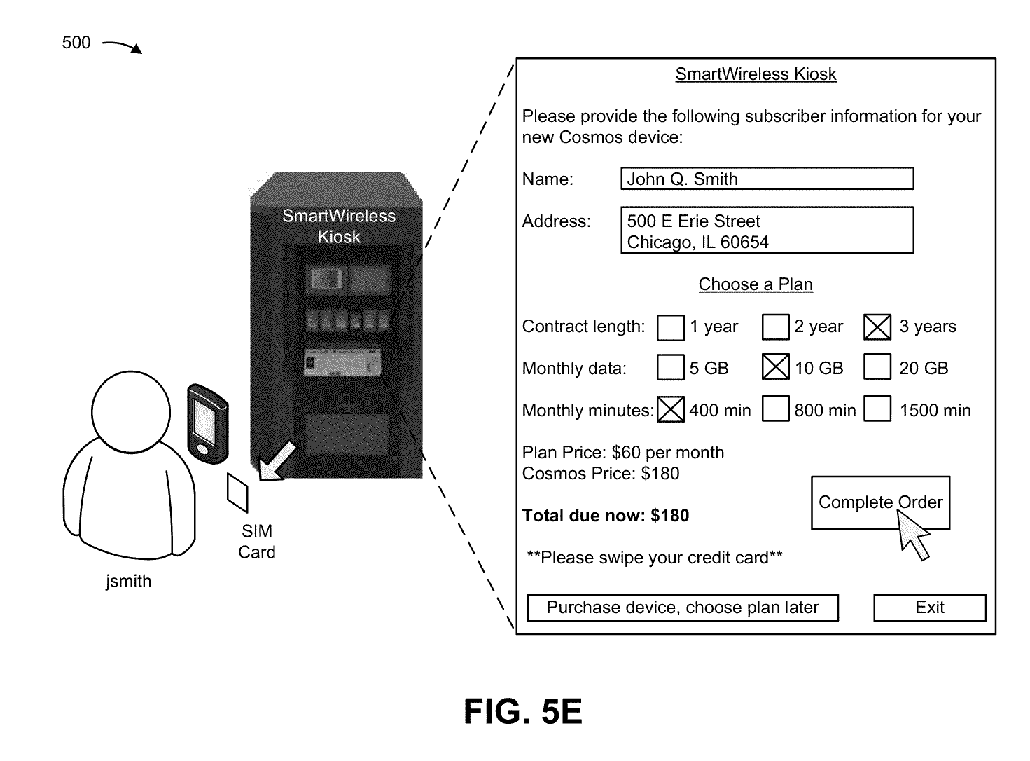

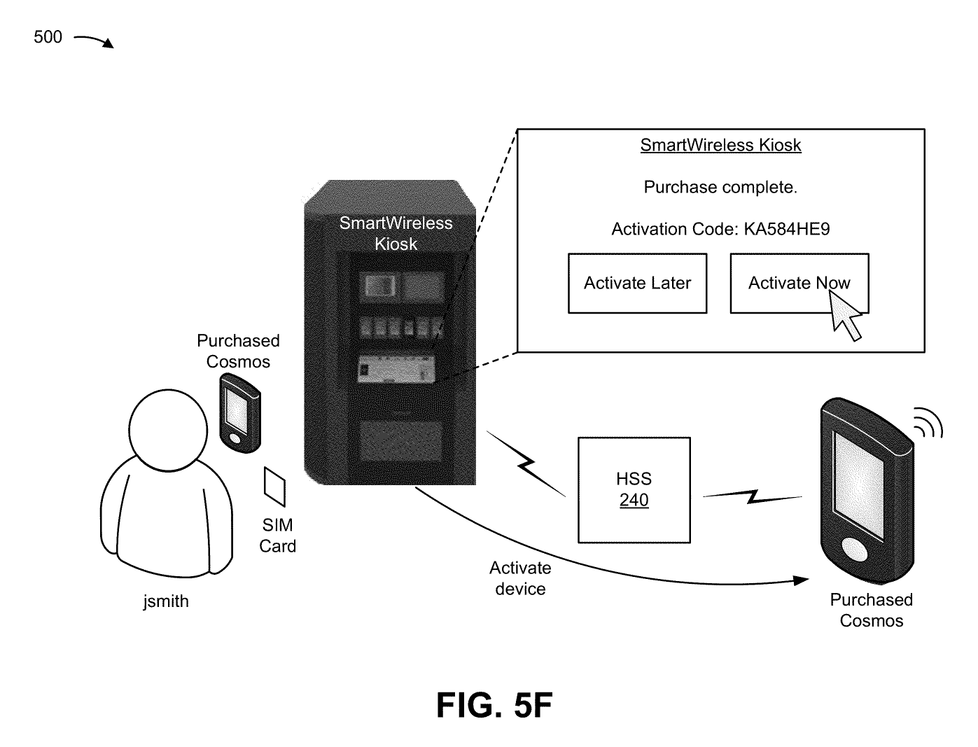

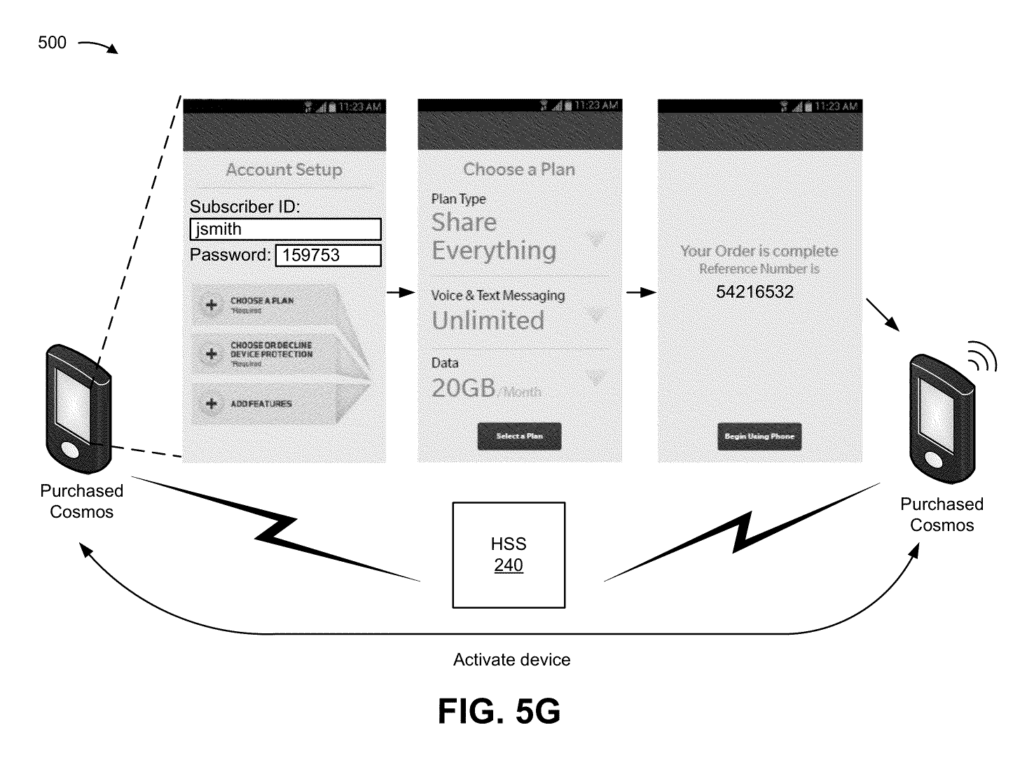

FIGS. 5A-5G are diagrams of an example implementation 500 relating to example process 400 shown in FIG. 4. For the purpose of example implementation 500, assume that a purchaser, jsmith, is accessing a website, associated with a SmartWireless service provider, to begin a purchase of a device that will be permitted to access a SmartWireless network. Further, assume that the purchaser has an account, associated with the SmartWireless website, that stores device information associated with the purchase. Finally, assume that the purchaser has initially decided to purchase a uPhone device, but wishes to examine the uPhone at a SmartWireless kiosk before completing the purchase, providing any subscription information, or providing payment information.

As shown in FIG. 5A, the purchaser may interact with a user interface of purchase information device 210 to provide device information, associated with the purchase of the uPhone device, using the SmartWireless website. For example, the purchaser may click an input element (e.g., an “Add to Cart” button, etc.) to indicate that the purchaser wishes to purchase the uPhone device for a cost of $200, as shown. Additionally, the purchaser may provide additional device information associated with the purchase of the uPhone, such as a SmartWireless Plan, additional accessories to be purchased, or the like. As shown in FIG. 5A, the purchaser has not selected a SmartWireless Plan to be associated with the uPhone device, or provided any other device information.

As further shown in FIG. 5A, the purchaser may interact with another input element (e.g., a “Complete/Pickup at Kiosk” button, etc.) to indicate that the purchase of the uPhone is to be completed at a SmartWireless kiosk. A SmartWireless server associated with the SmartWireless website (not shown) may store the device information provided by the purchaser. Additionally, the SmartWireless website may identify the location of the purchaser and provide the purchaser with a map and/or directions to a SmartWireless kiosk, containing the uPhone, that is geographically close to the location of the purchaser.

As shown in FIG. 5B, the purchaser may login to the SmartWireless kiosk, using the login information associated with the SmartWireless website account, in order to continue the purchase of the uPhone. For example, the purchaser may provide a username (e.g., jsmith) and a password (e.g., 159753) associated with the SmartWireless website account via an input mechanism (e.g., via a keyboard, a touch screen, etc.) included in the SmartWireless kiosk. The SmartWireless kiosk may determine the device information associated with the purchase of the uPhone by obtaining the device information from the SmartWireless server associated with the SmartWireless website (not shown).

As further shown in FIG. 5B, the SmartWireless kiosk may display the device information associated with the purchase of the uPhone. For example, the SmartWireless kiosk may display an indication that the purchaser has started the purchase of the uPhone device for $200. The SmartWireless kiosk may prompt the purchaser to choose whether to continue the purchase of the uPhone, based on the device information, or delete the device information associated with the purchase of the uPhone. As shown, the purchaser may indicate (e.g., by clicking a “Continue” button) that the purchaser wishes to continue the purchase of the uPhone.

As shown in FIG. 5C, the SmartWireless kiosk may dispense the uPhone to the purchaser. As shown, the purchaser may be required to provide credit card information before the uPhone will be dispensed. After the uPhone is dispensed to the purchaser, the purchaser may indicate that the purchaser no longer wishes to purchase the uPhone. For example, the purchaser may return the uPhone to the SmartWireless kiosk (e.g., via a doorway, a receiving slot, etc.) and indicate (e.g., by clicking a “Try Another” button) that the purchaser would like to the SmartWireless kiosk to dispense another device (e.g., the purchaser may decide to purchase a device other than the uPhone), as shown.

As shown in FIG. 5D, the SmartWireless kiosk may prompt the purchaser to select another device, housed within the SmartWireless kiosk. For example, the purchaser may indicate (by clicking a “Cosmos—$180” button) that the purchaser wishes to purchase a Cosmos device, as shown. As shown, the SmartWireless kiosk may dispense the Cosmos device to the purchaser. As further shown in FIG. 5D, the purchaser may indicate (e.g., by clicking a “Purchase” button) that the purchaser would like to purchase the Cosmos device.

As shown in FIG. 5E, the purchaser may provide subscription information associated with the purchase of the Cosmos device. For example, the subscription information may include information indicating a name to be associated with the Cosmos device (e.g., John Smith), an address to be associated with the Cosmos device (e.g., 500 E Erie Street, Chicago, Ill. 60654), information associated with the duration of the services to be provided to the Cosmos device (e.g., a 3 year contract), information associated with the services to be provided to the Cosmos device (e.g., 10 gigabytes (“GB”) of monthly data, 400 monthly minutes), and payment information to be associated with the purchase of the Cosmos device (e.g., credit card information), as shown. The SmartWireless kiosk may also display information associated with a monthly cost for service (e.g., $60), a cost for the Cosmos device (e.g., $180), and a total cost due at the time of purchase (e.g., $180). As shown, the purchaser may provide the subscription information and may choose to complete the purchase of the Cosmos device (e.g., by clicking on a “Complete Order” button). As further shown in FIG. 5E, the SmartWireless kiosk may program a SIM card with the information associated with the subscription information, and may dispense the SIM card to the user for insertion into the Cosmos device.

As shown in FIG. 5F, the SmartWireless kiosk may prompt the purchaser whether the purchaser would like to activate the Cosmos device. As shown, the purchaser may indicate (by clicking an “Activate Now” button) that the purchaser wishes to activate the Cosmos device from the SmartWireless kiosk. The SmartWireless kiosk may provide activation information, based on the subscription information, that permits the Cosmos device to be activated on the SmartWireless network. For example, the SmartWireless kiosk may provide the activation information to HSS 240 to activate the Cosmos device, as shown. As further shown, HSS 240 may activate the Cosmos device for use on the SmartWireless network.

Alternatively, as shown in FIG. 5G, assume that the purchaser chose only to purchase the Cosmos device using the SmartWireless kiosk (e.g., the purchaser did not provide any subscription information at the time of purchase). As shown in FIG. 5G, the purchaser may provide the necessary subscription information (e.g., a subscriber identifier associated with a SmartWireless account, a password associated with a SmartWireless account, a SmartWireless plan to be associated with the Cosmos device, etc.) using the Cosmos device itself.

As further shown in FIG. 5G, the Cosmos device may provide the activation information, based on the subscription information associated with the Cosmos device, to another device. For example, the Cosmos device may provide activation information, that permits the Cosmos device to be active on the SmartWireless network, to HSS 240. As shown, HSS 240 may activate the Cosmos device for use on the SmartWireless network.

As indicated above, FIGS. 5A-5G are provided merely as an example. Other examples are possible and may differ from what was described with regard to FIGS. 5A-5G.

Implementations described herein may allow a purchaser to purchase a device, provide subscription information associated with the device, and activate the device at a kiosk without having to visit a store associated with a service provider network.

The foregoing disclosure provides illustration and description, but is not intended to be exhaustive or to limit the implementations to the precise form disclosed. Modifications and variations are possible in light of the above disclosure or may be acquired from practice of the implementations.

As used herein, the term component is intended to be broadly construed as hardware, firmware, or a combination of hardware and software.

Certain user interfaces have been described herein. In some implementations, the user interfaces may be customizable by a device or a user. Additionally, or alternatively, the user interfaces may be pre-configured to a standard configuration, a specific configuration based on a type of device on which the user interfaces are displayed, or a set of configurations based on capabilities and/or specifications associated with a device on which the user interfaces are displayed.

It will be apparent that systems and/or methods, as described herein, may be implemented in many different forms of software, firmware, and hardware in the implementations illustrated in the figures. The actual software code or specialized control hardware used to implement these systems and/or methods is not limiting of the implementations. Thus, the operation and behavior of the systems and/or methods were described without reference to the specific software code—it being understood that software and control hardware can be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Further, the phrase “based on” is intended to mean “based, at least in part, on” unless explicitly stated otherwise.

What is claimed is:

1. A device, comprising:
one or more processors to:
determine device information associated with a user device housed within a kiosk, the device information identifying the user device;
dispense the user device based on the device information;
receive an indication that the user device is to be purchased;
receive subscription information associated with a purchaser of the user device based on receiving the indication; and
provide activation information that permits the user device to be activated on a network,
the activation information being based on the subscription information.

2. The device of claim 1, where the one or more processors, when determining the device information associated with the user device housed within the kiosk, are further to:
provide a user interface that includes information that identifies a plurality of user devices housed within the kiosk,
the plurality of user devices including the user device;
receive a user selection, via the user interface, that identifies the user device; and
where the one or more processors, when dispensing the user device, are further to:
dispense the user device based on the user selection.

3. The device of claim 1, where the one or more processors, when determining the device information associated with the user device housed within the kiosk, are further to:
receive information identifying the purchaser;
retrieve the device information based on the information identifying the purchaser; and
where the one or more processors, when dispensing the user device, are further to:
dispense the user device based on the retrieved device information.

4. The device of claim 1, where the one or more processors, when dispensing the user device based on the device information, are further to:
receive information identifying the purchaser of the user device; and
dispense the user device based on receiving the information.

5. The device of claim 1, where the one or more processors, when dispensing the user device based on the device information, are further to:
dispense a demonstration device based on the device information;
collect the demonstration device after dispensing the demonstration device; and
dispense the user device based on the indication that the user device is to be purchased and based on collecting the demonstration device.

6. The device of claim 1, where the one or more processors, when providing the activation information that permits the user device to be activated on the network, are further to:
program a component, to be integrated into the user device, with the activation information; and
dispense the component to be integrated into the user device.

7. The device of claim 1, where the one or more processors, when providing the activation information that permits the user device to be activated on the network, are further to:
provide information identifying the user device;
provide information identifying the purchaser of the user device; or
provide information identifying the subscription information associated with the user device.

8. A computer-readable medium storing instructions, the instructions comprising:
one or more instructions that, when executed by a processor, cause the processor to:
receive device information identifying a device stored in a kiosk;
dispense the device based on the device information;
determine that the device is to be purchased;
receive subscription information based on determining that the device is to be purchased; and
provide activation information associated with activation of the device on a network,
the activation information being based on the subscription information and a device identifier associated with the device.

9. The computer-readable medium of claim 8, where the one or more instructions, that cause the processor to receive the device information identifying the device stored in the kiosk, further cause the processor to:
provide a user interface that includes information that identifies a plurality of devices stored in the kiosk,
the plurality of devices including the device;
receive a user selection, via the user interface, that identifies the device; and
where the one or more instructions, that cause the processor to dispense the device, further cause the processor to:
dispense the device based on the user selection.

10. The computer-readable medium of claim 8, where the one or more instructions, that cause the processor to receive the device information identifying the device stored in the kiosk, further cause the processor to:
receive information identifying a purchaser associated with the device;
retrieve the device information based on the information identifying the purchaser; and
where the one or more instructions, that cause the processor to dispense the device, further cause the processor to:
dispense the device based on the retrieved device information.

11. The computer-readable medium of claim 8, where the one or more instructions, that cause the processor to dispense the device based on the device information, further cause the processor to:
receive information identifying a purchaser of the device; and
dispense the device based on receiving the information.

12. The computer-readable medium of claim 8, where the one or more instructions, that cause the processor to dispense the device based on the device information, further cause the processor to:
dispense a demonstration device based on the device information;
collect the demonstration device after dispensing the demonstration device; and
dispense the device based on the indication that the device is to be purchased and based on collecting the demonstration device.

13. The computer-readable medium of claim 8, where the one or more instructions, that cause the processor to provide the activation information associated with the activation of the device on the network, further cause the processor to:
program a component, to be integrated into the device, with the activation information; and
dispense the component to be integrated into the device.

14. The computer-readable medium of claim 8, where the one or more instructions, that cause the processor to provide the activation information associated with the activation of the device on the network, further cause the processor to:
provide information identifying the device;
provide information identifying the purchaser of the device; and
provide information identifying the subscription information associated with the device.

15. A method comprising:
determining, by a kiosk device, device information identifying a device housed within the kiosk device;
dispensing, by the kiosk device, the device based on the device information;
receiving, by the kiosk device, an indication that the device is to be purchased;
determining, by the kiosk device, subscription information associated with the device based on receiving the indication that the device is to be purchased; and
providing, by the kiosk device, activation information that allows the device to be activated on a network,
the activation information identifying the device and including the subscription information.

16. The method of claim 15, where determining the device information identifying the device housed within the kiosk device further comprises:
providing a user interface that includes information that identifies plurality of devices housed within the kiosk device,
the plurality of devices including the device;
receiving a user selection, via the user interface, that identifies the device; and
where dispensing the device further comprises:
dispensing the device based on the user selection.

17. The method of claim 15, where determining the device information identifying the device housed within the kiosk device further comprises:
receiving information identifying a purchaser associated with the device;
retrieving the device information based on the information identifying the purchaser; and
where dispensing the device further comprises:
dispensing the device based on the retrieved device information.

18. The method of claim 15, where dispensing the device based on the device information further comprises:
receiving information identifying a purchaser of the device; and
dispensing the device based on receiving the information.

19. The method of claim 15, where dispensing the device based on the device information further comprises:
dispensing a demonstration device based on the device information;
collecting the demonstration device after dispensing the demonstration device; and
dispensing the device based on the indication that the device is to be purchased and based on collecting the demonstration device.

20. The method of claim 15, where providing the activation information that allows the device to be activated on the network further comprises:
programming a component, to be integrated into the device, based on the activation information; and
dispensing the component to be integrated into the device.
